(19) United States
(12) Patent Application Publication
(10) Pub. No.: US 2006/0207867 A1
(43) Pub. Date: Sep. 21, 2006

(54) Rotary controls

(76) Inventor: George Waddington, (US)

Correspondence Address: COLLARD & ROE, P.C., 1077 Northern Boulevard, Roslyn, NY, 11576, US

(21) Appl. No.: 11/377,854

(22) Filed: Mar. 16, 2006

(30) Foreign Application Priority Data
Mar. 17, 2005 (GB) 0505451.5

(51) Int. Cl. H01H 9/00

(52) U.S. Cl. 200/315

(57) ABSTRACT

A rotary control or control knob 10 comprises an outer rotatable sleeve 12 and a fixed inner core 11. The sleeve has contacts 15 which interact with an encoder 17. The core 11 includes a fibre optic device comprising a bundle of parallel glass fibre optics 19 which conduct light from a matrix 21 on a panel 14 below the core 11, to a diffuse screen 20 at the top thereof. The matrix comprises LED's which are of greater size than the diameter of the individual fibres of the fibre optic device. The sleeve 12 may be conductive and coupled to a touch sensitive circuit and may be located over a piezoelectric switch 26 operable by pressure on the top of the core 11.

This invention relates to improvements in rotary controls for use for example in conjunction with music mixing desks and related control functions.

A music mixing desk comprises a multiplicity of rotary controls, to control simultaneously several hundreds up to over a thousand functions or channels. It is desirable to have a display associated with each control to indicate for example the volume level or other parameter which is subject to adjustment by that particular control. In the past this has been effected by bar graphs or other displays on the panel adjacent to the rotary control, but this had the disadvantage that viewing of the displays is often obstructed by the rotary controls which project out of the panel.

To overcome this, it was proposed to provide displays in the exposed tops of the controls themselves, and in U.S. Pat. No. 5,450,075 lights are mounted on the control surface, and propagated to the tops of the knobs using light pipes. As the control knob is rotated, the system updates the arrangement of lights illuminated on the control panel. The lights are transmitted up the light pipes, which are at the sides of the knob to the top of the knob for viewing by the operator. This arrangement provides illumination at the top of the knob to enhance the readability of the control panel.

Another prior art approach to providing illuminated displays indicative of parameter values in connection with rotary controls is to mount the lights on the control panel in a skirt around the base of the knob. However, if the parameter value happens to be obscured by the knob from the view point of the operator, the value is unreadable, and thus as the operator views a large number of knobs on the board, it will be impossible to determine the values set on a significant proportion of these knobs.

U.S. Pat. No. 6,438,241 proposes that a control knob should comprise an outer rotatable part which is turned to effect the control function, and a central stator part, on the exposed top end of which is provided an array of lights such as LED's, for example in an arcuate array. The illumination of the lights is controlled by circuitry coupled to a sensor which senses relative rotation of the rotatable part.

In the prior art devices, such as these described in the above patent specifications, the display is limited to a fairly low resolution representation, as an arc of illuminated light conduits or LED's, of for example sound volume, or other parameter, currently set by the respective control knob. Also, where light pipes are used, the alignment of these with the light sources on the panel is critical to provide a clear indication. For example if a light pipe receives light from more than one light on the panel, the display at the top of the knob is blurred. On the otherhand the requirement for circuitry to control an LED display on each knob leads also to complexity and expense in manufacture.

Because of the limitations of the prior art devices, it is an object of the invention to provide an improved rotary control which will enable a variety of displays to be made use of, as well as or instead of a simple arc or bar graph.

According to the present invention a rotary control or control knob comprises an inner core member which is fixed relative to a support panel, an outer sleeve member which is rotatable relative to the core member and to the support panel and is operatively connected to control means whereby a parameter may be varied by rotation of the sleeve member, the panel member having an array of light emitting or transmitting elements forming a matrix below the inner core member, and the core member comprising an array of parallel light conducting elements adapted to conduct light from said matrix of the panel member to the top end of the core to thereby form an image corresponding to the display formed by said matrix.

The array of parallel light conducting elements in the core preferably comprises an array of fibre optic devices, such as a glass fibre optic bundle. The fibre optic devices may advantageously have smaller dimensions than the elements of the matrix of light emitting or transmitting elements of the panel, so that there are a plurality of fibre optic devices associated with each matrix element to ensure clear reproduction of the illuminated part of the matrix to be visible at the top end of the core.

The sleeve member may be operatively connected to control means by means of contact members extending down from the lower edge of the sleeve, to cooperate with an encoder device, located below the sleeve member and disposed about the core member. Movement of the contacts by rotation of the sleeve may operate switches in the encoder device to operate the control means, and vary the relevant parameters, such as sound volume, pitch or quality.

An embodiment of an improved rotary control device according to the invention will now be described by way of example with reference to the accompanying drawings, wherein:—

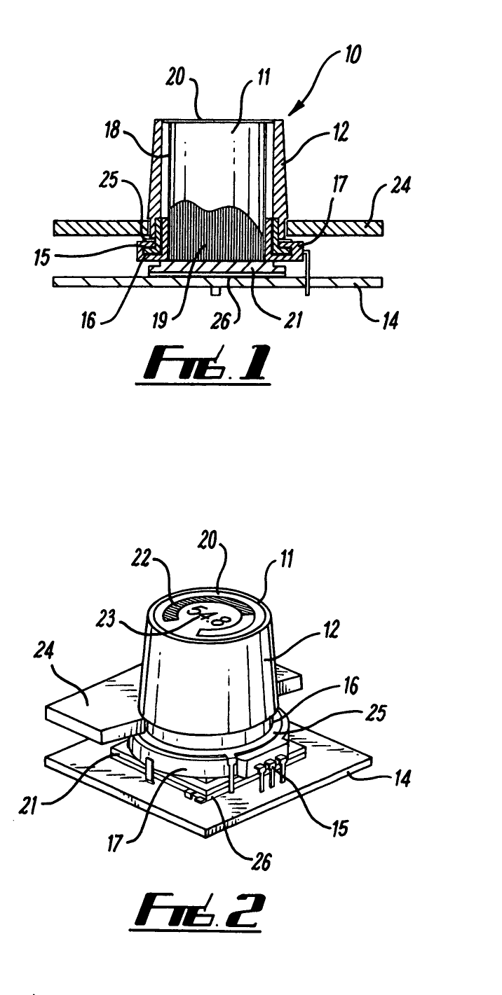

FIG. 1 is an axial sectional view of an embodiment of a rotary control knob according to the invention; and

FIG. 2 is a perspective view of the control knob shown in FIG. 1.

The improved rotary control device according to the invention comprises a rotary control knob 10, which comprises an inner cylindrical core 11, and an outer coaxial sleeve 12 which is rotatable relative to the core 11 and has a generally tapered or frusto-conical profile.

The core 11 is fixed and non-rotatable relative to a mounting panel 14.

The sleeve 12 has contacts 15 disposed about its lower edge, which are received in a circular slot 16 in a casing of an encoder 17. The interaction of the contacts 15 with components of the encoder 17 as the sleeve 12 is rotated causes the encoder to instruct a subservient device to vary a parameter to be controlled by the knob 10, such as the volume of a particular sound input to or output from the desk.

The stationary core 11 comprises a cylindrical wall 18, a diffuse screen 20 and a central body 19 consisting of a fibre optic device, comprising a multiplicity of parallel glass fibre optical light conductors extending from the bottom of the core 11 to the top, so that a light image impressed upon the fibre optic body 19 at one end will become apparent to one viewing the other end of the body 19.

The core 11 and fibre optic body 19 is located over a matrix 21 in the panel 14 of light emitting or conducting devices. These may be self-luminous elements such as LEDs or light conductors such as further fibre optic elements. The LEDs or the like of the matrix 21 are greater in dimension than the diameter of the fibre optic elements forming the fibre optic body 19 in the core 11, for example the diameter of each LED may be 2 to 3 or more times that of each fibre optic element. This will have the advantage that the image at the diffuse screen 20 at the top end of the core 11 will have a greater resolution in “pixels” than the matrix 21, so that a clear well defined image of the illuminated parts of the matrix 21 will be obtained. This will minimise blurring of the image which might be caused by light from two or more matrix elements entering a single light conductor which is possible when the diameter of the latter is similar to the dimensions of the matrix elements.

The image which is manifested at the upper end surface of the core 11 on the diffuse screen 20 may optionally comprise a graphical representation of the value of the controlled parameter, such as sound volume, and this may be shown as an arc 22 of variable extent, or as a bar graph or pie graph (where a segment of variable angular extent is shown) neither of which are shown in FIG. 2, or a numerical display 23 corresponding to a value in standard units of the parameter may be shown, in place of or together with the graphical display, or any alpha-numeric display.

The display made possible by the improved rotary control knob according to the invention has advantages with respect to the known prior art of the clarity of image, and versatility of display, which is limited only by the programming capabilities of the device used to drive the matrix 21.

It may for example be possible to switch between display modes to alternate, or simultaneously display graphical and numerical displays.

In one arrangement the rotatable sleeve 12 is a conductive material capacitively coupled by a ring 25 to a touch sensitive circuit.

The whole assembly is located over a piezoelectric switch device 26 to facilitate a switching function when the operator presses or taps the diffuse screen 20.

1. A rotary control or control knob comprising an inner core member which is fixed relative to a support panel, an outer sleeve member which is rotatable relative to the core member and to the support panel and is operatively connected to control means whereby a parameter may be varied by rotation of the sleeve member, the panel member having an array of light emitting or transmitting elements forming a matrix below the inner core member, and the core member comprising an array of parallel light conducting elements adapted to conduct light from said matrix of the panel member to the top end of the core to thereby form an image corresponding to the display formed by said matrix.

2. A rotary control according to claim 1 wherein the array of parallel light conducting elements in the core comprises an array of fibre optic devices.

3. A rotary control according to claim 2, wherein the fibre optic devices comprise a glass fibre optic bundle wherein the individual light conducting elements are comprised by fibres having smaller dimensions than the elements of the light emitting or transmitting elements of the panel.

4. A rotary control according to claim 1 wherein the sleeve members is operatively connected to control means by means of contact member extending down from the lower edge of the sleeve, to cooperate with an encoder device, located below the sleeve member and disposed about the core member, whereby movement of the contacts by rotation of the sleeve may operate switches in the encoder device to operate the control means and thereby vary the relevant parameters.

5. A rotary control according to claim 1 wherein the top end of the inner core member is provided with a diffuse screen.

6. A rotary control according to claim 1 wherein the matrix of light emitting or transmitting elements on the panel below the core member comprises an array of LED s.

7. A rotary control according to claim 1 wherein the rotatable sleeve comprises a conductive material which is coupled to a touch sensitive circuit.

8. A rotary control according to claim 7 wherein said coupling is effected capacitively by a ring about the base of the sleeve.

9. A rotary control according to claim 7 wherein the rotatable sleeve and fixed inner core member are located over a piezoelectric switch device which is operable by pressing or touching of the top end of the core member.
